(19) United States
(12) Patent Application Publication
(10) Pub. No.: US 2025/0254380 A1
(43) Pub. Date: Aug. 7, 2025

(54) SYSTEMS AND METHODS FOR GENERATING A SMART OVERLAY FOR AN INTERACTIVE DISPLAY

(71) Applicant: STATS LLC, Chicago, IL (US)

(72) Inventors: Nicholas Peter COCKERILL, Roberttown (GB); Thomas BRUGGER, Graz (AU)

(73) Assignee: STATS LLC, Chicago, IL (US)

(21) Appl. No.: 19/042,804

(22) Filed: Jan. 31, 2025

Related U.S. Application Data
(60) Provisional application No. 63/549,235, filed on Feb. 2, 2024.

(51) Int. Cl. H04N 21/431; H04N 21/2187; H04N 21/81

(52) U.S. Cl. CPC H04N 21/4316; H04N 21/2187; H04N 21/8133

(57) ABSTRACT

Techniques described herein relate to a computer-implemented method for generating a smart overlay in an interactive display. The method may include receiving a plurality of real-time event data comprising a plurality of real-time event actions, receiving a plurality of user data comprising a plurality of user actions, capturing one or more real-time user interactions with the interactive display, generating a unique relevancy threshold using the plurality of real-time event actions, the plurality of user actions, and the one or more real-time user interactions, as the plurality of real-time event data and the one or more real-time user interactions are received, generating, in real-time, at least one unique smart overlay that may have a relevancy that exceeds the unique relevancy threshold, and updating, in real-time, the interactive display with the at least one unique smart overlay.

### CROSS-REFERENCE TO RELATED APPLICATIONS

This application claims priority to U.S. Provisional Application Ser. No. 63/549,235, filed Feb. 2, 2024, which is hereby incorporated by reference in its entirety.

### TECHNICAL FIELD

Various embodiments of the present disclosure relate generally to computer-implemented techniques for generating an interactive display and, more particularly, to systems and methods for generating a smart overlay for an interactive display.

### INTRODUCTION

User interfaces that display content that is irrelevant to a user may significantly hinder user experience. Users may struggle to identify essential information in cluttered layouts with excessive elements. Irrelevant content may also obscure critical actions or information, reducing the interface's usability and effectiveness. Prioritization of user needs may mitigate one or more of these challenges.

Unless otherwise indicated herein, the techniques and information described in this section are not prior art to the claims in this application and are not admitted to be prior art, or suggestions of the prior art, by inclusion in this section.

### SUMMARY

In some aspects, the techniques described herein relate to a computer-implemented method for generating a smart overlay in an interactive display. The method may include receiving a plurality of real-time event data comprising a plurality of real-time event actions. The method may further include receiving a plurality of user data comprising a plurality of user actions. The method may further include capturing one or more real-time user interactions with the interactive display. The method may further include generating a unique relevancy threshold using the plurality of real-time event actions, the plurality of user actions, and the one or more real-time user interactions. The unique relevancy threshold may be generated in real-time as the plurality of real-time event data and the one or more real-time user interactions are received. The method may further include generating, in real-time, at least one unique smart overlay that may have a relevancy that exceeds the unique relevancy threshold. The method may further include updating, in real-time, the interactive display with the at least one unique smart overlay.

In some aspects, the techniques described herein relate to a system for generating a smart overlay in an interactive display. The system may include a memory storing instructions and a processor operatively connected to the memory and configured to execute the instructions to perform operations. The operations may include receiving a plurality of real-time event data comprising a plurality of real-time event actions. The operations may further include receiving a plurality of user data comprising a plurality of user actions. The operations may further include capturing one or more real-time user interactions with the interactive display. The operations may further include generating a unique relevancy threshold using the plurality of real-time event actions, the plurality of user actions, and the one or more real-time user interactions. The unique relevancy threshold may be generated in real-time as the plurality of real-time event data and the one or more real-time user interactions are received. The operations may further include generating, in real-time, at least one unique smart overlay that may have a relevancy that exceeds the unique relevancy threshold. The operations may further include updating, in real-time, the interactive display with the at least one unique smart overlay.

In some aspects, the technique described herein relate to a non-transitory computer-readable medium storing instructions that, when executed by one or more processors, perform a method for generating a smart overlay in an interactive display. The method may include receiving a plurality of real-time event data comprising a plurality of real-time event actions. The method may further include receiving a plurality of user data comprising a plurality of user actions. The method may further include capturing one or more real-time user interactions with the interactive display. The method may further include generating a unique relevancy threshold using the plurality of real-time event actions, the plurality of user actions, and the one or more real-time user interactions. The unique relevancy threshold may be generated in real-time as the plurality of real-time event data and the one or more real-time user interactions are received. The method may further include generating, in real-time, at least one unique smart overlay that may have a relevancy that exceeds the unique relevancy threshold. The method may further include updating, in real-time, the interactive display with the at least one unique smart overlay.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 depicts a block diagram illustrating a computing environment, according to example embodiments.

FIG. 2 depicts a flow diagram for a method for generating a smart overlay in an interactive display.

FIGS. 3A-3L depict embodiments of smart overlays displayed within an interactive display.

FIG. 4 depicts a flow diagram for training an artificial intelligence model, according to example embodiments.

FIGS. 5A-5B depicts a block diagram illustrating a computing device, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

According to techniques and systems disclosed herein, an overlay may be dynamically generated and displayed over a video stream (e.g., a live video stream, a broadcast video stream, etc.). The overlay may include various sports information such, as but not limited, to player information, play information, team information, sport information, and/or the like. Such information may be generated based on sports data such as event data and/or tracking data. The event data and/or tracking data may be generated based on an in-venue stream or a broadcast stream. The event data and/or tracking data may be generated, for example, using one or more machine learning models trained to output such data based on inputs including the in-venue stream, broadcast stream, tagged data, etc.

An overlay may be partially transparent such that a video stream is visible through the overlay. An overlay may be interactive such that a user (e.g., a user of a user device) may select the overlay or a subset of the overlay (e.g., a button, icon, etc.). Such interaction may allow a user to take an odds based action (e.g., make a market prediction, perform a fantasy sport action). The overlay may be dynamically determined based on event data and may provide an odds based option based on the event data. A potential market prediction may be automatically generated based on an event action associated with a sport that corresponds to the video stream. The potential market prediction may be provided to a user device to be displayed via the overlay using a graphical user interface (GUI) of the user device. For example, an event action associated with the sporting event may be a corner kick to be taken by a given team. Based on identification of the event action via the associated event data, a market prediction option associated with the corner kick (e.g., whether a goal will nor will not be scored) may be generated having associated odds. The market prediction option may be provided via the overlay such that user may be able to select the market prediction prior to the corner kick being performed. By selecting the market prediction option, a secondary overlay or a new interface may be provided to the user to confirm the market prediction, provide or display information associated with the market prediction, and/or the like.

An overlay position and/or content may be determined based on the event data, as discussed herein. The overlay position may be dynamic such that, for example, the overlay position may change based on a change in a camera angle, a view, a player movement, a team, a team having possession, a game action (e.g., a goal, a kick, a penalty, a pass, a score, a block, time based attributes, etc.). Similarly, overlay content may be dynamic such that, for example, the overlay content may change based on a change in a camera angle, a view, a player movement, a team, a team having possession, a game action, a player attribute, a player statistic, time based attributes, etc.).

Additionally, user interactions may be captured and processed by the disclosed computing system to determine aspects of the interactive display and/or smart overlay. Such aspects may include how the interactive display and/or smart overlay are displayed within a user interface (e.g., positioning within the user interface), when they are displayed (e.g., after a user interaction and/or in conjunction with real-time sports event data, and the like), what content is displayed (e.g., within the interactive display and/or smart overlay), and the like. The interactive display and/or smart overlay may therefore be updated and/or generated “on-the-fly” by the computing system, based on the captured user interactions. In an example, if a user places a market prediction via the interactive display and/or a smart overlay, additional related and/or relevant content may be presented to the user via the interactive display, smart overlay, or by the presentation of additional smart overlay content determined to be relevant to the user interaction. The interactive display and/or smart overlay may therefore be tailored to each unique user, based on user-specific input.

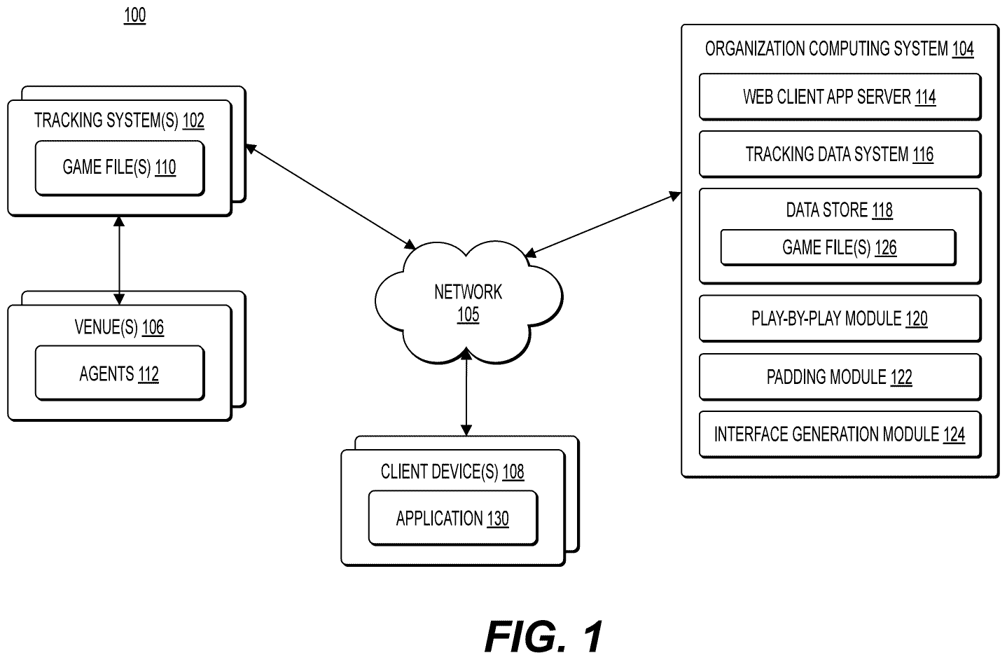

FIG. 1 is a block diagram illustrating a computing environment 100, according to example embodiments. Computing environment 100 may include tracking system 102 (e.g., positioned at or in communication with one or more components positioned at venue 106), organization computing system 104, and one or more client devices 108 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

Tracking system 102 may be positioned in a venue 106 and/or may be in communication (e.g., electronic communication, wireless communication, wired communication, etc.) with components located at venue 106. For example, venue 106 may be configured to host a sporting event that includes one or more agents 112. Tracking system 102 may be configured to capture the motions of one or more agents (e.g., players) on the playing surface, as well as one or more other agents (e.g., objects) of relevance (e.g., ball, puck, referees, etc.). In some embodiments, tracking system 102 may be an optically-based system using, for example, a plurality of fixed cameras, movable cameras, one or more panoramic cameras, etc. For example, a system of six calibrated cameras (e.g., fixed cameras), which project three-dimensional locations of players and a ball onto a two-dimensional overhead view of the playing surface may be used. In another example, a mix of stationary and non-stationary cameras may be used to capture motions of all agents on the playing surface as well as one or more objects or relevance. Utilization of such a tracking system (e.g., tracking system 102) may result in many different camera views of the playing surface (e.g., high sideline view, free-throw line view, huddle view, face-off view, end zone view, etc.).

In some embodiments, tracking system 102 may be used for a broadcast feed of a given match. For example, tracking system 102 may be used to generate game files 110 to facilitate a broadcast feed of a given match. In such embodiments, each frame of the broadcast feed may be stored in a game file 110. A broadcast feed may be a feed that is formatted to be broadcast over one or more channels (e.g., broadcast channels, internet based channels, etc.). A game file 110 may be converted from a first format (e.g., a format output by the one or more cameras or a different format than the format output by the one or more cameras) and may be converted into a second format (e.g., for broadcast transmission).

In some embodiments, game file 110 may further be augmented with other event information corresponding to event data, such as, but not limited to, game event information (pass, made shot, turnover, etc.) and context information (current score, time remaining, etc.). According to embodiments, event data may be generated manually or may be generated by a computing system in real time (e.g., within approximately 30 seconds of an event occurring), as discussed herein. A computing system may generate the event data by, for example, analyzing tracking data (e.g., from tracking system 102), and/or one or more other data types such as a video feed, excitement data, etc. The computing system may utilize a machine-learning model to determine when given tracking data or changes in tracking data (e.g., given player movements, object movements, changes in the same, etc.) correspond to an event (e.g., a scoring event, a penalty event, a possession based event, play type event, etc.). Event data may be automatically identified using a machine-learning trained to receive, as an input, a game file 110 or a subset thereof and output game information and/or context information based on the input. The machine-learning model may be trained using supervised, semi-supervised, or unsupervised learning, in accordance with the techniques disclosed herein. The machine-learning model may be trained by analyzing training data using one or more machine-learning algorithms, as disclosed herein. The training data may include game files or simulated game files from historical games, simulated games, and/or the like and may include tagged and/or untagged data.

Tracking system 102 may be configured to communicate with organization computing system 104 via network 105. For example, tracking system 102 may be configured to provide organization computing system 104 with a broadcast stream of a game or event in real-time or near real-time via network 105. As an example, tracking system 102 may provide one or more game files 110 in a first format (e.g., corresponding to a format based on the components of tracking system 102). Alternatively, or in addition, tracking system 102 or organization computing system 104 may convert the broadcast stream (e.g., game files 110) into a second format, from the first format. The second format may be based on the organization computing system 104. For example, the second format may be a format associated with data store 118, discussed further herein.

Organization computing system 104 may be configured to process the broadcast stream of the game. Organization computing system 104 may include at least a web client application server 114, tracking data system 116, data store 118, play-by-play module 120, padding module 122, and/or interface generation module 124. Each of tracking data system 116, play-by-play module 120, padding module 122, and interface generation module 124 may be comprised of one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather than as a result of the instructions.

Tracking data system 116 may be configured to receive broadcast data from tracking system 102 and generate tracking data from the broadcast data. In some embodiments, tracking data system 116 may apply an artificial intelligence and/or computer vision system configured to derive player-tracking data from broadcast video feeds.

To generate the tracking data from the broadcast data, tracking data system 116 may, for example, map pixels corresponding to each player and ball to dots and may transform the dots to a semantically meaningful event layer, which may be used to describe player attributes. For example, tracking data system 116 may be configured to ingest broadcast video received from tracking system 102. In some embodiments, tracking data system 116 may further categorize each frame of the broadcast video into trackable and non-trackable clips. In some embodiments, tracking data system 116 may further calibrate the moving camera based on the trackable and non-trackable clips. In some embodiments, tracking data system 116 may further detect players within each frame using skeleton tracking. In some embodiments, tracking data system 116 may further track and re-identify players over time. For example, tracking data system 116 may reidentify players who are not within a line of sight of a camera during a given frame. In some embodiments, tracking data system 116 may further detect and track an object across a plurality of frames. In some embodiments, tracking data system 116 may further utilize optical character recognition techniques. For example, tracking data system 116 may utilize optical character recognition techniques to extract score information and time remaining information from a digital scoreboard of each frame.

Such techniques assist in tracking data system 116 generating tracking data from the broadcast feed (e.g., broadcast video data). For example, tracking data system 116 may perform such processes to generate tracking data across thousands of possessions and/or broadcast frames. In addition to such process, organization computing system 104 may go beyond the generation of tracking data from broadcast video data. Instead, to provide descriptive analytics, as well as a useful feature representation for interface generation module 124, organization computing system 104 may be configured to map the tracking data to a semantic layer (e.g., events).

Tracking data system 116 may be implemented using a machine-learning model. The machine-learning model may be trained using supervised, semi-supervised, or unsupervised learning, in accordance with the techniques disclosed herein. The machine-learning model may be trained by analyzing training data using one or more machine-learning algorithms, as disclosed herein. The training data may include game files or simulated game files from historical games, simulated games, historical or simulated feature representations, and/or the like and may include tagged and/or untagged data. The tagged data may include position information, movement information, object information, trends, agent identifiers, agent re-identifiers, etc.

Play-by-play module 120 may be configured to receive play-by-play data from one or more third party systems. For example, play-by-play module 120 may receive a play-by-play feed corresponding to the broadcast video data. In some embodiments, the play-by-play data may be representative of human generated data based on events occurring within the game. Even though the goal of computer vision technology is to capture all data directly from the broadcast video stream, the referee, in some situations, is the ultimate decision maker in the successful outcome of an event. For example, in basketball, whether a basket is a 2-point shot or a 3-point shot (or is valid, a travel, defensive/offensive foul, etc.) is determined by the referee. As such, to capture these data points, play-by-play module 120 may utilize machine-learning outputs and/or manually annotated data that may reflect the referee's ultimate adjudication. Such data may be referred to as the play-by-play feed.

To help identify events within the generated tracking data, tracking data system 116 may merge or align the play-by-play data with the raw generated tracking data (which may include the game and time fields). Tracking data system 116 may utilize a fuzzy matching algorithm, which may combine play-by-play data, optical character recognition data (e.g., shot clock, score, time remaining, etc.), and play/ball positions (e.g., raw tracking data) to generate the aligned tracking data.

Once aligned, tracking data system 116 may be configured to perform various operations on the aligned tracking system. For example, tracking data system 116 may use the play-by-play data to refine the player and ball positions and precise frame of the end of possession events (e.g., shot/rebound location). In some embodiments, tracking data system 116 may further be configured to detect events, automatically, from the tracking data. In some embodiments, tracking data system 116 may further be configured to enhance the events with contextual information.

For automatic event detection, tracking data system 116 may include a neural network system trained to detect/refine various events in a sequential manner. For example, tracking data system 116 may include an actor-action attention neural network system to detect/refine one or more of: shots, scores, points, rebounds, passes, dribbles, penalties, fouls, and/or possessions. Tracking data system 116 may further include a host of specialist event detectors trained to identify higher-level events. Exemplary higher-level events may include, but are not limited to, plays, transitions, presses, crosses, breakaways, post-ups, drives, isolations, ball-screens, offside, handoffs, off-ball-screens, and/or the like. In some embodiments, each of the specialist event detectors may be representative of a neural network, specially trained to identify a specific event type. More generally, such event detectors may utilize any type of detection approach. For example, the specialist event detectors may use a neural network approach or another machine-learning classifier (e.g., random decision forest, SVM, logistic regression etc.).

While mapping the tracking data to events enables a player representation to be captured, to further build out the best possible player representation, tracking data system 116 may generate contextual information to enhance the detected events. Exemplary contextual information may include defensive matchup information (e.g., who is guarding who at each frame, defensive formations), as well as other defensive information such as coverages for ball-screens or presses.

In some embodiments, to measure influence, tracking data system 116 may use a measure referred to as an “influence score.” The influences score may capture the influence a player may have on each other player on an opposing team on a scale of 0-100. In some embodiments, the value for the influence score may be based on sport principles, such as, but not limited to, proximity to player, distance from scoring object (e.g., basket, goal, boundary, etc.), gap closure rate, passing lanes, lanes to the scoring object, and the like.

Padding module 122 may be configured to create new player representations using mean-regression to reduce random noise in the features. For example, one of the profound challenges of modeling using potentially only limited games (e.g., 20-30 games) of data per player may be the high variance of low frequency events seen in the tracking data. Therefore, padding module 122 may be configured to utilize a padding method, which may be a weighted average between the observed values and sample mean.

Accordingly, for each player, tracking data system 116, play-by-play module 120, and padding module 122 may work in conjunction to generate a raw data set and a padded data set for each player.

Interface generation module 124 may be configured to generate an overlay and/or interactive display using the data received by tracking data system 116. In various embodiments, interface generation module 124 may be configured to generate an overlay and/or interactive display based on a video feed (e.g., broadcast feed, in-venue feed), tracking data, and/or event data. The interactive display may include at least one of a graphical representation of one or more of the aspects described herein. In various embodiments, the interactive display is generated in real-time as the data is received (e.g., by tracking data system 116).

Data store 118 may be configured to store one or more game files 126. Each game file 126 may include video data of a given match. For example, the video data may correspond to a plurality of video frames captured by tracking system 102, the tracking data derived from the broadcast video as generated by tracking data system 116, play-by-play data, enriched data, and/or padded training data. Game files 126 may be based, for example, on game files 110 as discussed herein. Game files 126 may be in a different format than game files 110. For example, a first format of game files 110 or a subset thereof may be transformed into a second format of game files 126. The transformation may be performed automatically based on the type and/or content of the first format and the type and/or content of the second format.

Client device 108 may be in communication with organization computing system 104 via network 105. Client device 108 may be operated by a user. For example, client device 108 may be a mobile device, a tablet, a desktop computer, or any computing system having the capabilities described herein. Users may include, but are not limited to, individuals such as, for example, subscribers, clients, prospective clients, or customers of an entity associated with organization computing system 104, such as individuals who have obtained, will obtain, or may obtain a product, service, or consultation from an entity associated with organization computing system 104.

Client device 108 may include at least application 130. Application 130 may be representative of a web browser that allows access to a website or a stand-alone application. Client device 108 may access application 130 to access one or more functionalities of organization computing system 104. Client device 108 may communicate over network 105 to request a webpage, for example, from web client application server 114 of organization computing system 104. For example, client device 108 may be configured to execute application 130 to generate smart triggers. The content that is displayed to client device 108 may be transmitted from web client application server 114 to client device 108, and subsequently processed by application 130 for display through a graphical user interface (GUI) of client device 108.

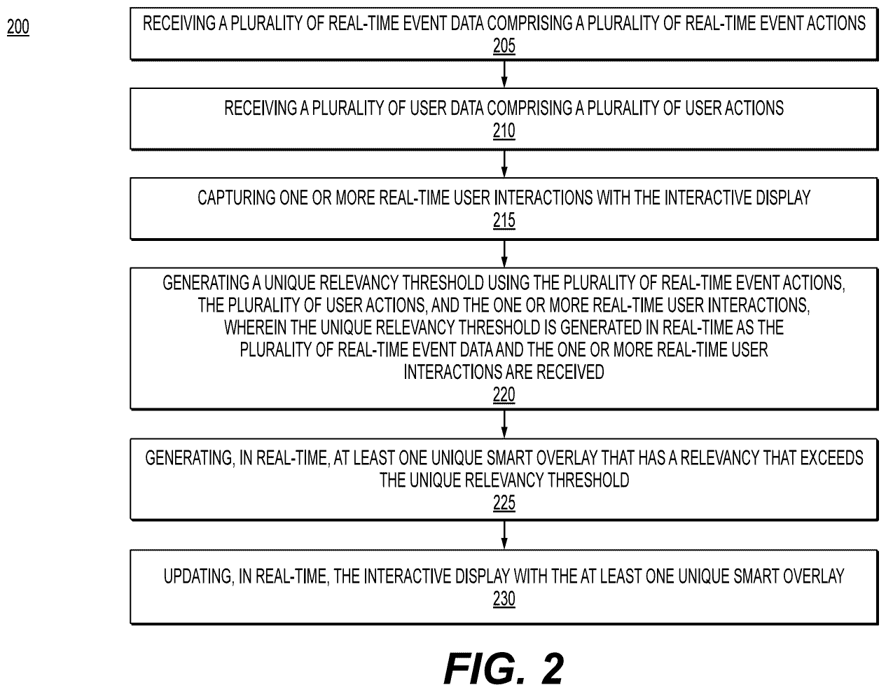

FIG. 2 depicts a flow diagram for a method 200 for generating a smart overlay in an interactive display. At step 205, a plurality of real-time event data is received. The plurality of real-time event data may include real-time event actions. The plurality of real-time event actions may include at least one of a scored goal, a completed pass, an interception, a goal conceded, or no action. Real time sporting event data (e.g., player data, match data, team data, performance data, trend data, etc.) may be leveraged with user data, market prediction data, and/or the like to provide a personalized smart overlay (e.g., via a live stream, video feed, and the like). The real-time event data may be generated and/or provided based on a video feed (e.g., broadcast feed, in-venue feed), tracking data, and/or event data. For example, tracking data may be generated (e.g., based on a content feed) by converting visual and/or audio elements of the content feed into digital depictions of agents (e.g., players) and/or objects (e.g., balls, pucks, etc.). The movement, trends, actions, and or predicted versions of the same for the agents and/or objects may be correlated with event types to determine when given movements, trends, actions, or predicted versions of the same correspond to an event. For example, the digital representation of an object (e.g., ball) crossing a digital representation of a boundary (e.g., a goal post) may result in a goal action being determined.

At step 210, a plurality of user data is received. The plurality of user data may include a plurality of user actions. In examples, user data may include data associated with a user profile, user historical interactions with a platform or software modules as described herein, types and/or categories of user interactions, user historical market predictions, types and/or categories of user historical market predictions, user preferences (e.g., user-selected and/or user preferences as learned by a machine-learning and/or artificial intelligence model, such as a user's preferences for sports team(s) or player(s)), and the like.

At step 215, one or more real-time user interactions with the interactive display may be captured. In various embodiments, the real-time user interactions may be captured by recording or tracking system events such as clicks, cursor movements, text entries, haptic input, screen unlocking, voice input, speech to text input, and the like. Such interactions may also be associated with a timestamp and stored (such as in data store 118, as depicted in FIG. 1), or may be delivered to an interface generation module (such as interface generation module 124, as depicted in FIG. 1) as a data stream (e.g., as the user interactions are occurring in real-time). As such, the one or more real-time user interactions may inform real-time updates to the user interface made by the interface generation module. In examples, such updates to the user interface may include highlighting elements, adding elements, removing elements, repositioning icons or elements, and the like, in the user interface. At step 220, a unique relevancy threshold may be generated using the plurality of real-time event actions, the plurality of user actions, and the one or more real-time user interactions. The unique relevancy threshold may be generated in real-time as the plurality of real-time event data and the one or more real-time user interactions are received. For example, pricing information (e.g., associated with market predictions, selections, teams, sports, etc.), sporting event data (e.g., associated with sports statistics, insights, ratings, and/or predictive metrics such as those generated using artificial intelligence), and/or user data (e.g., a user profile, previous actions taken by the user on market predictions, user market predictions, user favorites, price ranges, etc.) may be integrated to provide user specific, personalized smart overlays. In examples, a machine-learning or artificial intelligence model may determine the unique relevancy threshold by analyzing scoring metrics and correlating user data. For example, metrics such as groundedness, retrieval, and contextual precision may be used to assign scores based on how well one or more previous smart overlays align with user interactions and context. In another example, threshold calibration may improve the unique relevancy threshold by setting a “cutoff” value to classify outputs as relevant to a user or not. In another example, features highly correlated with user needs, preferences, and the like may be identified by a machine-learning or artificial intelligence model using rank correlation, decision trees, and the like.

In various embodiments, smart overlays may be customized by an operator (e.g., an entity or automated system that provides content via the smart overlays). In examples, smart overlays may be provided based on events happening in real-time game play (e.g., in the live video feed or broadcast) such as goals, shots, fouls, offsides, corners, passes, tackles, and the like. The smart overlay that is generated and shown in the user interface may contain information about individual player statistics, team totals for relevant statistics (e.g., relevant to the user) and enhanced metrics that are determined using artificial intelligence or machine-learning models, such as momentum shift, big points (e.g., ahead of a point which has a big impact on win probability), big point conversion rate, and the like. In other examples, insights may be displayed as smart overlays based on various triggers (e.g., an interaction from the user, a change in the unique relevancy threshold, events happening in real-time game play, and the like. In certain embodiments, an operator (e.g., automated system) may switch on/off triggers, such as when an operator does not offer markets on tackles, they may switch off the trigger associated with that event.

At step 225, at least one unique smart overlay that has a relevancy that exceeds the unique relevancy threshold may be generated. Gathered and/or generated data that may be used to generate one or more overlays and/or the interactive display may include user data (e.g., a user's favorite team, a user's number of market predictions placed on a team, market prediction history, and the like), event data (e.g., a score made by a player or team that changes the context or potential outlook of the game history), context data (e.g., excitement data gathered by smart ratings, such as increased interactions over a predetermined period of time and the like), and transaction triggers (e.g., a successful previous interaction with a similar overlay, such as a market prediction placed and the like).

According to embodiments of the disclosed subject matter, a smart overlay may include providing sporting event data and/or information generated based on sporting event data via a content stream such as a sports feed or via sports stories. Such a content stream may be accessed via a user device (e.g., an application having an interface that provides sports related content). The content stream may include content selected based on the integration of pricing information, sporting event data, and/or user data. Accordingly, the content stream may include content is relevant to a given user. The content stream may further be populated with supplementary content (e.g., advertising content) that is based on the user data and/or sporting event data.

At step 230, the interactive display with the at least one unique smart overlay may be updated in real-time. The interactive display may be displayed on a user mobile device. In examples, the at least one unique smart overlay may be an interactive interface overlaid on a live video stream on the user device. In various embodiments, a position of the at least one unique smart trigger within the interactive display may be automatically determined based on one or more of the plurality of real-time event actions, the plurality of user actions, the one or more real-time user interactions, and a camera angle of a live video stream. For example, a smart overlay may be arranged, reordered, updated, or etc. relative to the interactive display, relative to one or more other smart overlays, or relative to a live video stream, based on the relevancy of the smart overlay, or the plurality of real-time event actions, the plurality of user actions, the one or more real-time user interactions, and/or the camera angle of a live video stream. As such, the at least one unique smart overlay may be generated and/or updated based on one or more of the plurality of real-time event actions, the plurality of user actions, the one or more real-time user interactions, and/or the camera angle of a live video stream. In further aspects, the interactive display may be updated in real-time based on the plurality of real-time event actions, the plurality of user actions, and/or the one or more real-time user interactions.

In various embodiments, the unique smart overlay may push information to the user based on events happening on the field, court, or the like. Alternatively, users may decide on when they want to gather information which may affect how the smart overlay is updated in real-time. In various embodiments, performance metrics may be generated using one or more artificial intelligence and/or machine-learning models. Such performance metrics may be updated and displayed in real-time via one or more smart overlays. For example, players may be sorted according to a real-time performance metric. Clicking on a player in the smart overlay in the interactive interface or on a device screen may allow a user to gather more details about the individual statistics contributing to the player's performance metric. User may also interact with one or more market predictions (e.g., via the smart overlay) associated with the live video stream and performance metrics.

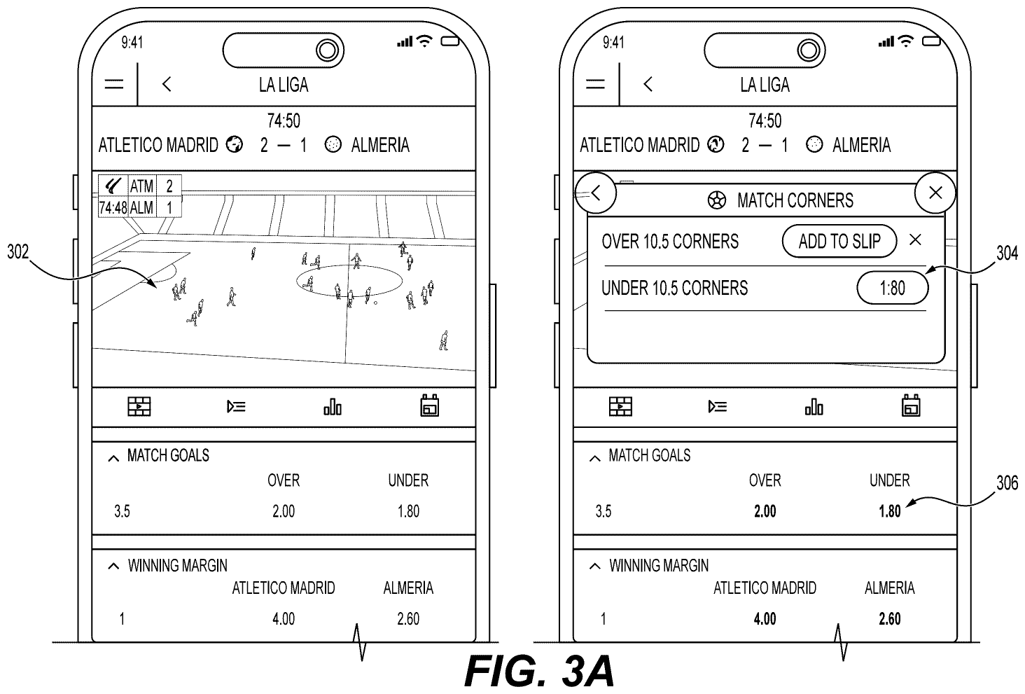

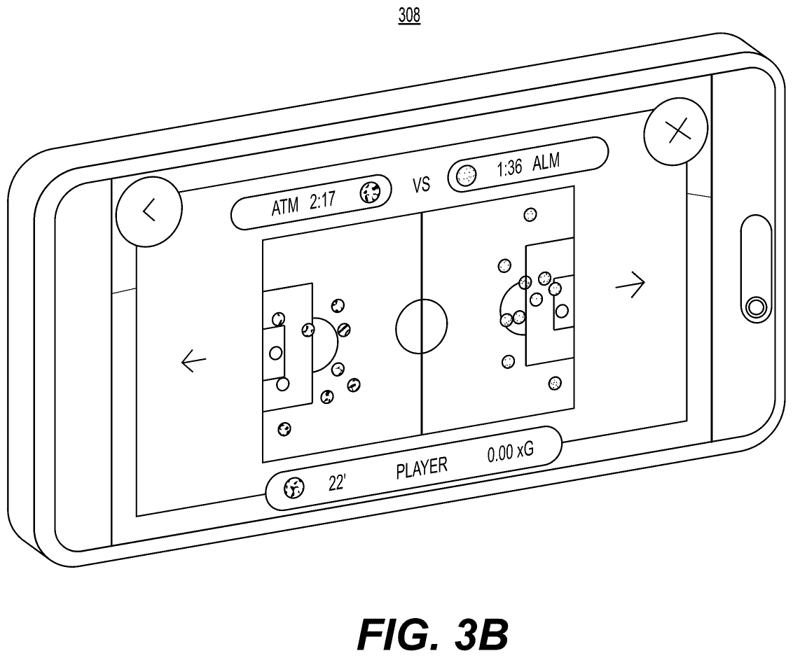

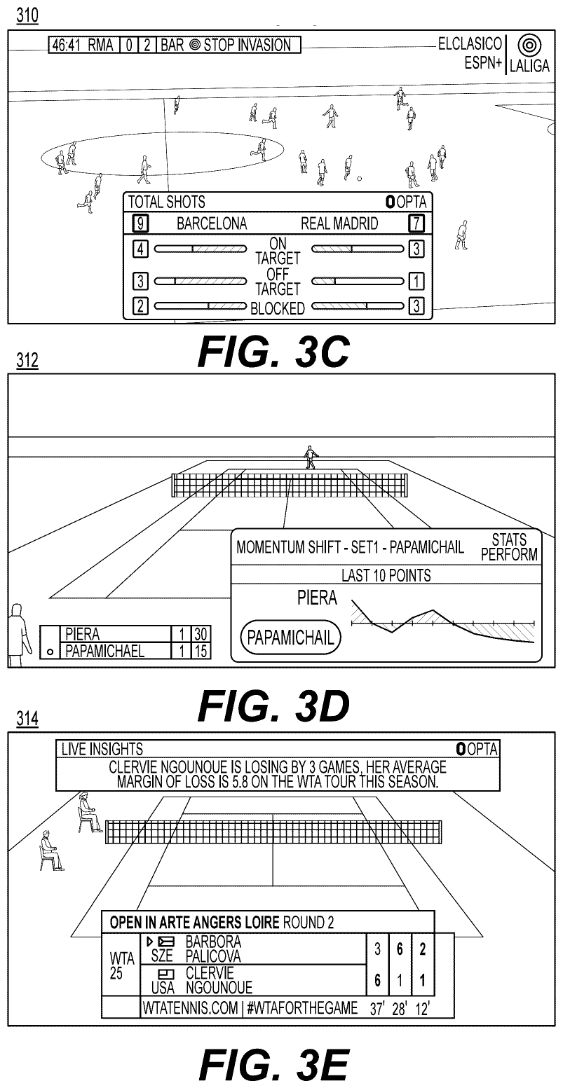

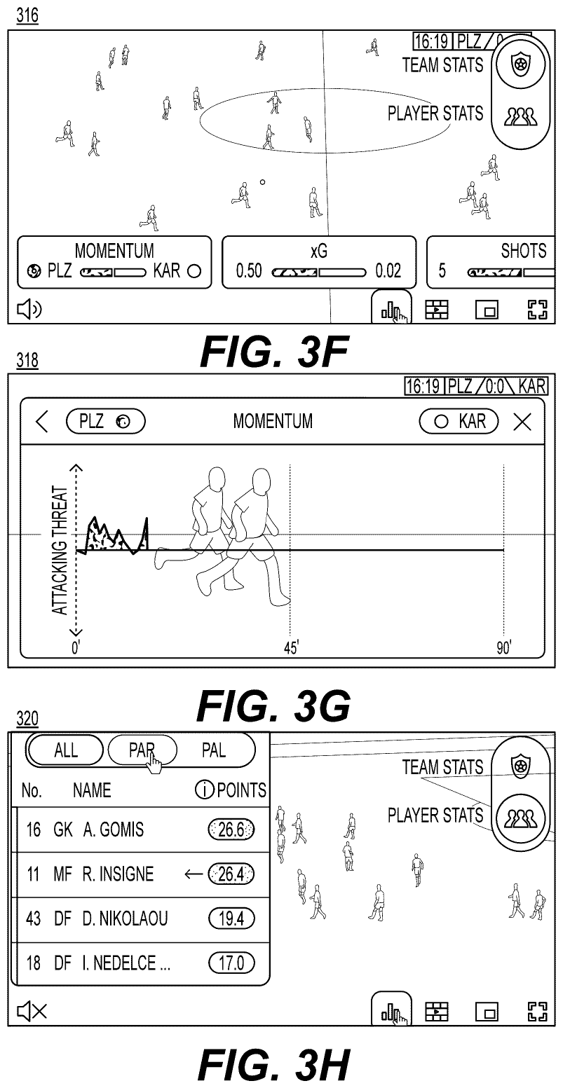

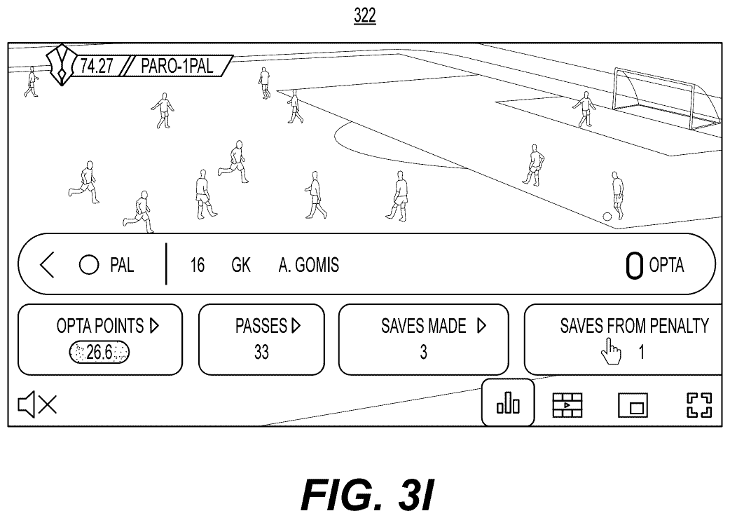

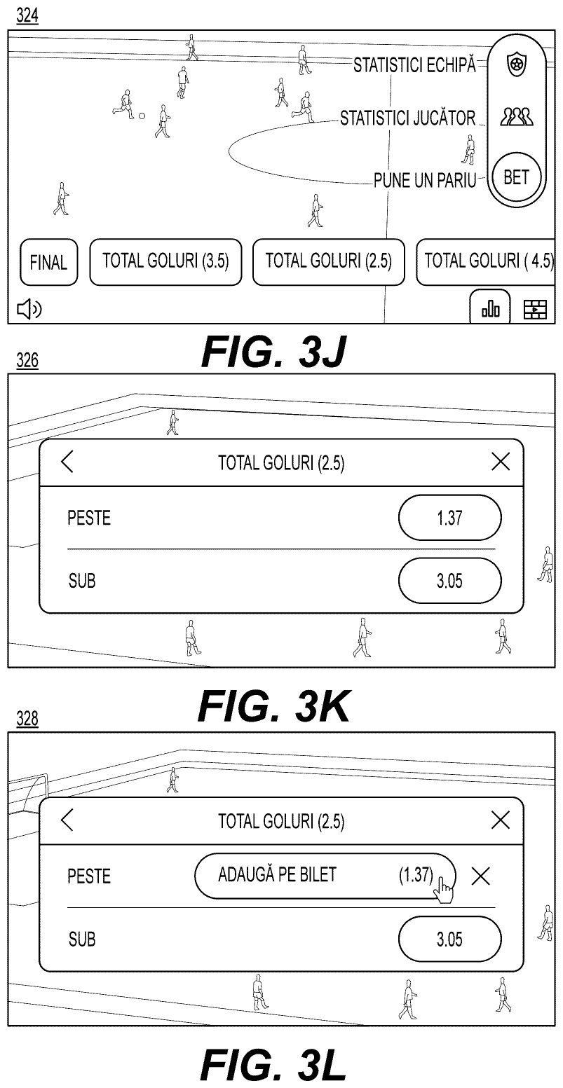

FIGS. 3A-3L depict embodiments of smart overlays displayed within an interactive display. As discussed herein, an overlay (e.g., a smart overlay) may be provided over a video stream. For example, a smart overlay may provide sports statistics and/or other sports related information over a video stream of the corresponding sporting event. In such examples, sports data (e.g., event data) may be overlaid onto a video stream (e.g., live video). The sports data may be related to a player, game play, team based statistics, and the like. In various embodiments, the overlaid graphical representation of the data may be interactive. Portions of the displayed data may be selected (e.g., clicked on), which may result in the generation of a new overlay display and/or redirection to a new video, webpage, or the like. In other examples, interacting with the smart overlay display may allow the computing system to gather data or information from the user, may allow the user to make a market prediction, and the like. The interactions presented within the smart overlay display may present relevant information in real-time. For example, an opportunity to make a market prediction related to a game being broadcast via the video stream in real-time may be presented. In one example, a user may be prompted to make a market prediction, via the smart overlay display, on the outcome of a corner kick about to take place in the broadcast. In another example, the smart overlay display may be used in the context of fantasy sports predictions.

In various embodiments, the position of the smart overlay display may be determined based on detected event data. In this way, the smart overlay display may not impede the user's view of game play. The computing system may use various methods to use event data and/or analysis of visual data to determine how to display the smart overlay display based on real-time game play. According to embodiments, the computing system may analyze a video feed, in real-time, to determine key areas of information and non-key areas of information. A machine learning model may classify all or a subset of the portions of a video feed (e.g., each frame) as cither being a key area or a non-key area. Such a classification may be output by the machine learning model that is trained to perform such classifications based on historical or simulated video or content feed data, tagged key areas, tagged non-key areas, and/or the like. An overlay module or other component may identify an optimal non-key area to display the smart overlay such that key areas are not obfuscated by the overlay. For example, the overlay module may score each non-key area using a machine learning model (e.g., the same machine learning model that classified key and non-key areas or a separate machine learning model). The score may be based on factors such as a size of the display area associated with each non-key area, a prominence of non-key areas, proximity of non-key areas to the corresponding information of the smart overlay to be displayed, and/or the like. The smart overlay display may take on various formats based on game play, user preference, and data or interactions to be displayed. Additionally, the user may choose to hide the smart overlay display (e.g., for a time).

In various embodiments, a smart overlay may be dynamically generated such that content is ordered or otherwise displayed based on the live event data associated with a sporting event. The content to be displayed, the positioning of the content, and/or the position of the overlay may be output by a machine learning model, as discussed herein. For example, a machine learning model may receive, as inputs, one or more of sporting event data, a video stream associated with the sporting event data, player information, team information, and/or the like. The machine learning model may be trained using historical or simulated event data, overlay information, and/or the like. The machine learning model may output a position information, content, market prediction information, fantasy sport information, and/or the like based on the inputs.

As shown in FIG. 3A, a smart overlay 304 may be displayed over a video stream 302. The smart overlay may, for example, include interactive market prediction options such that a user may be able to interact with overlay 304 to select an interactive market prediction option. As discussed herein, smart overlay 304 may be dynamically generated. A secondary interface 306 may also be dynamically generated upon generation of smart overlay 304. Secondary interface 306 may be populated to provide information supplemental to smart overlay 304. For example, as shown in FIG. 3A, smart overlay 304 may provide a market prediction related to a number of predicted corner kicks associated with the sporting event displayed via video stream 302. Secondary interface 306 may be populated to include sporting event data relevant to the market prediction options of smart overlay 304. In various embodiments, the interactive display with smart overlay may be displayed on a mobile device, as depicted in image 308 of FIG. 3B. It is contemplated that the interactive display and smart overlays may be displayed on any type of user device, such as mobile device, desktop or laptop computing device, television, smart watch, tablet, and the like.

As described herein, the positioning of the smart overlay and/or interactive display in a display of a computing device may be relative to other elements, and as such, the positioning of the smart overlay or elements within the smart overlay may be determined in real-time based on other factors such as a live video feed or the like. As depicted in image 310 of FIG. 3C, the interactive display or smart overlay is positioned at the bottom, center of the screen so that the smart overlay does not impede viewing of the broadcast (e.g., of a soccer game). As depicted in image 312 of FIG. 3D, the interactive display or smart overlay is positioned at the bottom, right of the screen (e.g., as with a broadcast of a tennis match). As depicted in image 314 of FIG. 3E, the interactive display or smart overlay may alternatively be positioned at the top, center of the screen during a tennis broadcast, depending upon the positioning of one or more display elements of the broadcast.

As described herein, the interactive display may include one or more smart overlays that are displayed. As depicted in image 316 of FIG. 3F, smart overlays depicting “team stats” may be displayed to overlay a live video feed. According to the example depicted in FIG. 3F, a user may toggle between “team stats” and “player stats,” with the interactive display updating to show “team stats” based on the user action of selecting “team stats” via the toggle element. As depicted in image 318 of FIG. 3G, upon user interaction with the smart overlay, the interactive display may be updated with a smart overlay (e.g., fullscreen) displaying additional content or information. As depicted in image 320 FIG. 3H, smart overlays depicting “player stats” may be displayed to overlay a live video feed based on user interaction with a toggle element. Further, as depicted in image 322 of FIG. 3I, upon user interaction with the smart overlay (e.g., as depicted in FIG. 3H), the interactive display may be updated with a smart overlay (e.g., fullscreen) displaying additional content or information.

In various embodiments, a toggle element of the interactive display may include a market prediction element, as depicted in image 324 of FIG. 3J. Interaction with elements in a market prediction smart overlay may update the interactive display to show current odds, as depicted in image 326 of FIG. 3K. Further, and as depicted in image 328 of FIG. 3L, user interaction with one or more elements of the smart overlay may update the interactive display with an option to place a market prediction for a determined value.

In various embodiments, one or more of the unique relevancy threshold, the plurality of real-time event actions, the plurality of user actions, and the one or more real-time user interactions may be provided to one or more artificial intelligence models as input.

In various embodiments, a generative artificial intelligence model may be trained to learn user interests by analyzing one or more patterns in user interactions with the user interface or smart overlays (e.g., mouse clicks, text input, speech input, haptic input, or visual data input). The generative artificial intelligence model may leverage machine-learning techniques, such as deep learning to process user behavior and contextual information. In examples, by tracking mouse clicks on specific content or elements in the user interface or smart overlay, the artificial intelligence model may infer user preferences based on a frequency or a type of the interactions (e.g., mouse clicks). In other examples, analyzing textual inputs, such as search queries or chat messages, may enable the generative artificial intelligence model to identify recurring topics, sentiment, or keywords that reflect user interests.

In further embodiments, speech and visual inputs may further enhance the learning process of the generative artificial intelligence model. In examples, a speech recognition system or component (e.g., as hardware components and/or software modules and specialized applications running on a user device) may transcribe spoken words into text and may extract emotional tone and/or intent. In further examples, computer vision algorithms may analyze uploaded images or videos (e.g., of the video stream or live broadcast) and identify objects, themes, players, elements, or styles of interest. In all such examples, the generative artificial intelligence model may refine (e.g., retrain) its understanding using reinforcement learning or feedback loops, thereby continuously updating predictions based on new user interactions. This personalized approach may allow the generative artificial intelligence model to tailor responses, recommendations, or content generation (e.g., the generation of the one or more smart overlays) to align more closely with individual user preferences.

In such embodiments, a user may interact with a live video stream or smart overlay using speech input. In a particular example, a user may be viewing (e.g., on a user device) a broadcast of a soccer game, and may say, “I like the jersey that player number 04 is wearing.” A generative artificial intelligence model, leveraging a speech recognition system, may analyze the video stream and identify the articles of clothing being referenced by the user. Using computer vision techniques, such as object detection and image segmentation, the artificial intelligence model may isolate the article of clothing being referenced and generate content recommendations, or deliver advertisements, for display within a smart overlay. Such content recommendations or advertisements may include invitations to the user to interact with links to purchase the same or similar jersey, links to additional information about the jersey or player, and the like. For example, the identification of the object (e.g., article of clothing) may trigger a web search for the corresponding object for sale. The search may result in one or more links to the object. If multiple links are identified, a machine learning model may generate a score for each link, and the link with the highest score may be presented to a user via a smart overlay. The score may be based on historical or simulated data (e.g., user purchase data, user merchant preferences, merchant credibility, etc.), pricing information, shipping times and/or locations, and/or the like.

In further embodiments, a generative artificial intelligence model may receive (e.g., as input) tracking data and/or event data as discussed herein. The generative artificial intelligence model may be trained to identify associations or patterns within the tracking data, event data, and live video data to generate one or more smart overlays in a user interface of a user device associated with a user that is associated with a good or service (e.g., a merchant). Based on the identified associations or patterns, advertisement space (e.g., advertisements presented within the live video stream, advertisements presented in a smart overlay provided to a consumer-user, and the like) may be auctioned to the user associated with the good or service. In such examples, the value and/or type of advertisement space may be dynamically updated based on the associations and patterns identified in the tracking data, event data, and live video data by the generative artificial intelligence model (e.g., based on real-time “game play” and elements thereof). An advertisement may be identified based on the auction, and may be presented via the identified advertisement space. In other embodiments, the generative artificial intelligence model may identify an advertisement space and a smart overlay which selects an advertisement from a repository of advertisements for display, where the selected advertisement has a highest score determined by the model. The score may be determined based on a correlation between the advertisement and a sporting event identified based on tracking data and/or event data.

According to embodiments of the disclosed subject matter, a generative artificial intelligence model may leverage historical user data, such as the types of content a user engages with, past market predictions made or acted upon by a user, frequency and timing of interactions, or specific features the interactions use, to identify trends and preferences unique to the user. In examples, if a user frequently interacts with certain types of market predictions (e.g., similar levels of risk, having to do with the same team or player, similar values, or the like), the generative artificial intelligence model may recommend, predict, or inform the generation of a unique smart trigger that aligns with the market predictions of interest. Using machine-learning techniques such as collaborative filtering, sequence modeling (e.g., recurrent neural networks), or reinforcement learning, the generative artificial intelligence model may predict what the user is likely to find engaging or useful next, and may then present such content to the user within the smart overlay. As more data is collected (e.g., as the user interacts in real-time), the generative artificial intelligence model may be retrained on the data allowing the model to become increasingly accurate. In examples, automated market prediction suggestions (e.g., with an invitation to interact) may be presented to the user via one or more smart overlays. In further examples, based on output from the generative artificial intelligence model, one or more market predictions may be automatically placed by the system, upon receiving user consent.

As discussed herein, one or more artificial intelligence models or machine-learning models may be trained to understand a sports language (e.g., a natural language model, or the like). Accordingly, machine-learning models disclosed herein are sports machine-learning models. Such sports machine-learning models may be trained using sports related data (e.g., tracking data, event data, etc., as discussed herein). A sports machine-learning model trained to understand a sports language based on sports related data may be trained to adjust one or more weights, layers, nodes, biases, and/or synapses based on the sports related data. A sports machine-learning model may include components (e.g., a weights, layers, nodes, biases, and/or synapses) that collectively associate one or more of: a player with a team or league; a team with a player or league; a score with a team; a scoring event with a player; a sports event with a player or team; a win with a player or team; a loss with a player or team; and/or the like. A sports machine-learning model may correlate sports information and statistics in a competition landscape. A sports machine-learning model may be trained to adjust one or more weights, layers, nodes, biases, and/or synapses to associate certain sports statistics in view of a competition landscape. For example, a win indicator for a given team may automatically correlated with a loss indicator for an opposing team. As another example, a score static may be considered a positive attribution for a scoring team and a negative attribution for a team being scored upon. As another example, a given score may be ranked against one or more scores based on a relative position of the score in comparison to the one or more other scores.

A sports machine-learning model may be trained based on sports tracking and/or event data, as discussed herein. Such data may include player and/or object position information, movement information, trends, and changes. For example, a sports machine-learning model may be trained by modifying one or more weights, layers, nodes, biases, and/or synapses to associate given positions in reference to the playing surface of venue and/or in reference to none or more agents. As another example, a sports machine-learning model may be trained by modifying one or more weights, layers, nodes, biases, and/or synapses to associate given movement or trends in reference to the playing surface of venue and/or in reference to none or more agents. As another example, a sports machine-learning model may be trained by modifying one or more weights, layers, nodes, biases, and/or synapses to associate sporting events with corresponding time boundaries, teams, players, coaches, officials, and environmental data associated with a location of corresponding sporting events.

A sports machine-learning model may be trained by modifying one or more weights, layers, nodes, biases, and/or synapses to associate position, movement, and/or trend information in view of a sports target. A sports target may be a score related target (e.g., a score, a goal, a shot, a shot count, a point, etc.), a play outcome (e.g., a pass, a movement of an object such as a ball, player positions, etc.), a player position, and/or the like. A sports machine-learning model may be trained in view sports targets, play outcomes, player positions, and/or the like associated with a given sport (e.g., soccer, American football, basketball, baseball, tennis, golf, rugby, hockey, a team sport, an individual sport, etc.). For example, a soccer based sports machine-learning model may be trained to correlate or otherwise associate player position information in reference to a soccer pitch. The soccer based sports machine-learning model may further be trained to correlate or otherwise associate sports data in reference to a number of players and sports targets specific to soccer.

According to aspects, one or more given sports machine-learning model types (e.g., generative learning, linear regression, logistic regression, random forest, gradient boosted machine (GBM), deep learning, graph neural networks (GNN) and/or a deep neural network) may be determined based on attributes of a given sport for which the one or more machine-learning models are applied. The attributes may include, for example, sport type (e.g., individual sport vs. team sport), sport boundaries (e.g., time factors, player number factors, object factors, possession periods (e.g., overlapping or distinct), playing surface type (e.g., restricted, unrestricted, virtual, real, etc.) player positions, etc.

According to aspects, a sports machine-learning model may receive inputs including sports data for a given sport and may generate a matrix representation based on features of the given sport. The sports machine-learning model may be trained to determine potential features for the given sport. For example, the matrix may include fields and/or sub-fields related to player information, team information, object information, sports boundary information, sporting surface information, etc. Attributes related to each field or sub-field may be populated within the matrix, based on received or extracted data. The sports machine-learning model may perform operations based on the generated matrix. The features may be updated based on input data or updated training data based on, for example, sports data associated with features that the model is not previously trained to associate with the given sport. Accordingly, sports machine-learning models may be iteratively trained based on sports data or simulated data.

As used herein, a “machine-learning model” or an “artificial intelligence model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine-learning techniques, such as generative learning, linear regression, logistic regression, random forest, gradient boosted machine (GBM), deep learning, graphical neural network (GNN), and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine-learning, it should be understood that techniques according to this disclosure may be adapted to any suitable type of machine-learning. It should also be understood that the examples above are illustrative only. The techniques and technologies of this disclosure may be adapted to any suitable activity.

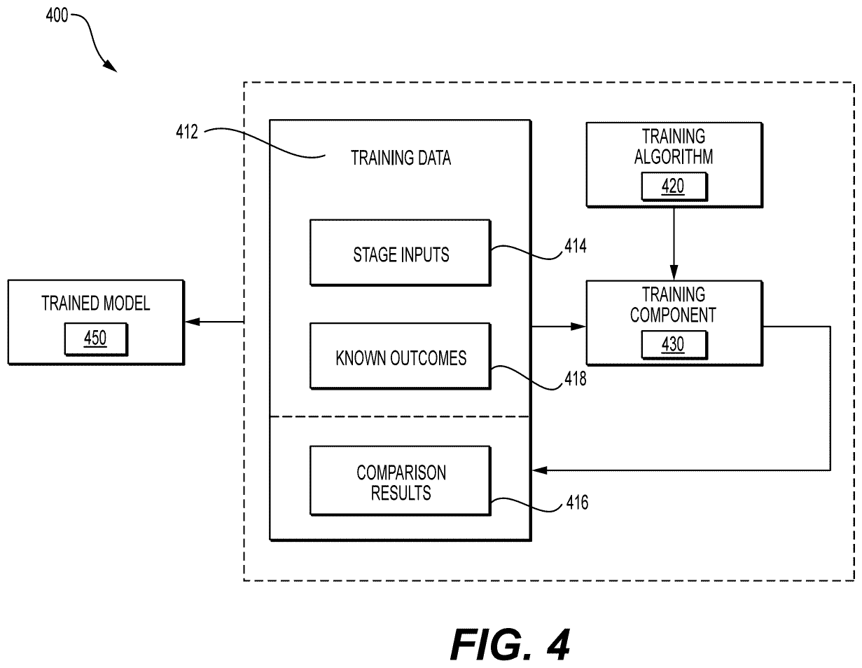

FIG. 4 depicts a flow diagram for training a machine-learning model, in accordance with an aspect of the disclosed subject matter. As shown in flow diagram 400 of FIG. 4, training data 412 may include one or more of stage inputs 414 and known outcomes 418 related to a machine-learning model to be trained. The stage inputs 414 may be from any applicable source including a component or set shown in the figures provided herein. The known outcomes 418 may be included for machine-learning models generated based on supervised or semi-supervised training. An unsupervised machine-learning model might not be trained using known outcomes 418. Known outcomes 418 may include known or desired outputs for future inputs similar to or in the same category as stage inputs 414 that do not have corresponding known outputs.

The training data 412 and a training algorithm 420 may be provided to a training component 430 that may apply the training data 412 to the training algorithm 420 to generate a trained machine-learning model 450. According to an implementation, the training component 430 may be provided comparison results 416 that compare a previous output of the corresponding machine-learning model to apply the previous result to re-train the machine-learning model. The comparison results 416 may be used by the training component 430 to update the corresponding machine-learning model. The training algorithm 420 may utilize machine-learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flow diagram 400 may be a trained machine-learning model 450.

In further aspects, and according to embodiments disclosed herein, a transformer neural network may receive inputs (e.g., tensor layers), where each input corresponds to a given player, team, or game. The transformer neural network may output generated predictions for one or more given players or teams based on such inputs. More specifically, the transformer neural network may output such generated predictions for a given player or team based on inputs associated with that given player or team and further based on the influence of one or more other players or teams. Accordingly, predictions provided by a transformer neural network, as discussed herein, may account for the influence of multiple players and/or teams when outputting a prediction for a given player and/or team.

The system described herein may include a machine-learning system configured to generate one or more predictions. In some examples, the system may incorporate a transformer neural network, graphical neural network, a recurrent neural network, a convolutional neural network, and/or a feed forward neural network. The system may implement a series of neural network instances (e.g., feed forward network (FFN) models) connected via a transformer neural network (e.g., a graph neural network (GNN) model). Although a transformer neural network is generally discussed herein, it will be understood that any applicable GNN, or other neural network that may utilize graphical interpretations, may be used to perform the techniques discussed herein in reference to a transformer neural network.

The transformer-based neural network may include a set of linear embedding layers, a transformer encoder, and a set of fully connected layers. The set of linear embedding layers may map component tensors of received inputs into tensors with a common feature dimension. The transformer encoder may perform attention along the temporal and agent dimensions. The set of fully connected layers may map the output embeddings from a last transformer layer of the transformer encoder into tensors with requested feature dimension of each target metric.

The transformer-based neural network may be configured to receive input features through the set of linear embedding layers. The input features may be received at different resolutions and over a time-series. The input features may relate to player features, team features, and/or game features. Input features may be input into the linear embedding layers as a tuple of input tensors. For example, a tuple of three tensors may be provided where the first tensor corresponds to all players in a match, a second tensor corresponds to both teams in the match, and the third tensor corresponds to a match state.

Examining the set of linear embedding layers, the linear embedding layers may contain a linear block for each input tensor of the tuple, and each block may map an input tensor to a tensor with a common feature dimension D. The output of the linear embedding layer may be a tuple of tensors, with a common feature dimension, which can be concatenated along the temporal and agent dimension to form a single tensor.

The transformer encoder may be configured to receive the single tensor from the linear embedding layers. The transformer encoder may be configured to learn an embedding that is configured to generate predictions on multiple actions for each agent (e.g., each player and/or team). The transformer encoder may include a series of axial transformer encoder layers, where each layer alternatively applies attention along the temporal and agent dimensions. The transformer encoder may include layers that alternate between temporally applying attention to sequences of action events, and applying attention spatially across the set of players and teams at each event time-step. The transformer encoder may include axial encoder layers configured to accept a tensor from the linear layers and apply attention along the temporal dimension, then along the agent dimension.

The attention mechanism that is implemented by the transformer encoder layers may have a graphical interpretation on a dense graph where each element is a node, and the attention mask is the inverse of the adjacency matrix defining the edges between the nodes (the absence of an attention mask thus implies a fully-connected graph). In the case of the axial attention used here, with the attention mask on the temporal (row) dimension, the nodes in the graph can be arranged in a grid, and each node may be connected to all nodes in the same column, and to all previous nodes in the same row. Attention, in this case, may be message-passing where each node can accept messages describing the state of the nodes in its neighborhood, and then update its own state based on these messages. This attention scheme may mean that when making a prediction for a particular player, the model may consider (i.e. attend to): the nodes containing the previous states of the player along the time-series; and the state nodes of the other players, team and the current game state in the current time-step. It may not be necessary for the nodes to be homogeneous-beyond having the same feature dimension-and thus a node that represents a player can accept messages from a node that represents at team, or from the player's strength node. The model may therefore learn the interactions between agents, and ensure consistent predictions for each agent along the time-series. The output of the transformer encoder layers may be a tensor (e.g., an output embedding).

The final layers of the transformer-based neural network may be the fully connected layers. These layers may map the output embedding of the final transformer layer of the transformer encoder to the feature dimension of each target metric. The final layers may output a target tuple that contains tensors for each of a set of modeled actions for each player and/or team. For example, the modeled action may be an empirical estimate of distributions for sport statistics such as number of shots taken, number of goals, number of passes, etc.

The training of the transformer-based neural network may include choosing a corresponding loss function for the distribution assumption of each output target. For example, the loss function may be the Poisson negative log-likelihood for a Poisson distribution, binary cross entropy for a Bernouilli distribution, etc. The losses may be computed during training according to the ground truth value for each target in the training set, and the loss values may be summed, and the model weights may be updated from the total loss using an optimizer. The learning rate may have been adjusted on a schedule with cosine annealing, without warm restarts.

A machine-learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine-learning model (e.g., a trained model) based on the training. Once trained, the machine-learning model may output machine-learning model outputs in accordance with the subject matter disclosed herein. According to an implementation, one or more machine-learning models disclosed herein may continuously update based on feedback associated with use or implementation of the machine-learning model outputs.

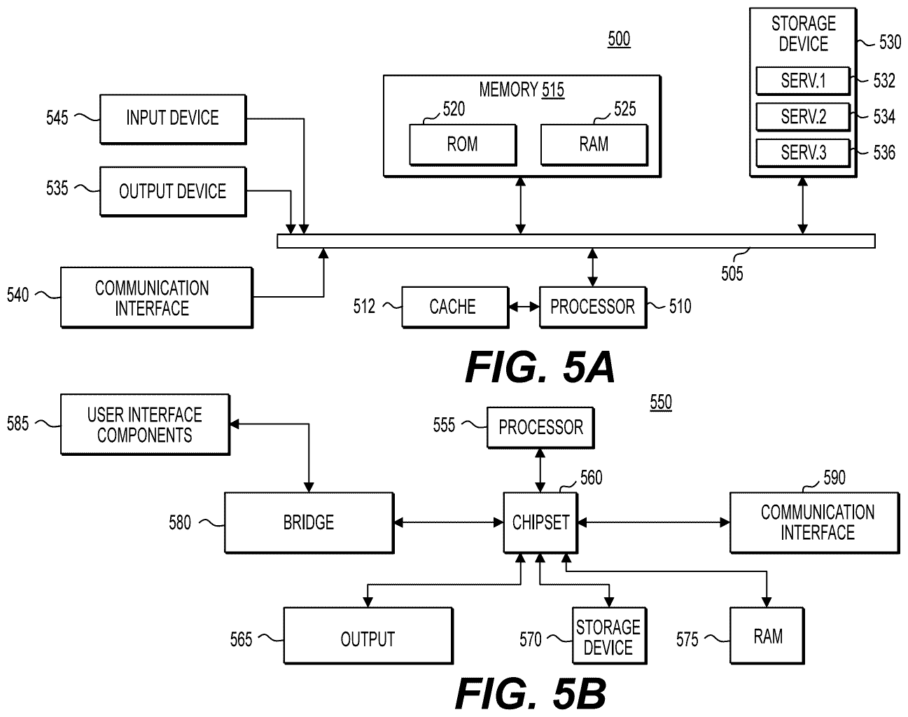

FIG. 5A illustrates an architecture of computing system 500, according to example embodiments. System 500 may be representative of at least a portion of organization computing system 104. One or more components of system 500 may be in electrical communication with each other using a bus 505. System 500 may include a processing unit (CPU or processor) 510 and a system bus 505 that couples various system components including the system memory 515, such as read only memory (ROM) 520 and random access memory (RAM) 525, to processor 510. System 500 may include a cache of high-speed memory connected directly with, in close proximity to, or integrated as part of processor 510. System 500 may copy data from memory 515 and/or storage device 530 to cache 512 for quick access by processor 510. In this way, cache 512 may provide a performance boost that avoids processor 510 delays while waiting for data. These and other modules may control or be configured to control processor 510 to perform various actions. Other system memory 515 may be available for use as well. Memory 515 may include multiple different types of memory with different performance characteristics. Processor 510 may include any general purpose processor and a hardware module or software module, such as service 1 532, service 2 534, and service 3 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction with the computing system 500, an input device 545 may represent any number of input mechanisms, such as a microphone for speech, a touch-sensitive screen for gesture or graphical input, keyboard, mouse, motion input, speech and so forth. An output device 535 (e.g., display) may also be one or more of a number of output mechanisms known to those of skill in the art. In some instances, multimodal systems may enable a user to provide multiple types of input to communicate with computing system 500. Communications interface 540 may generally govern and manage the user input and system output. There is no restriction on operating on any particular hardware arrangement and therefore the basic features here may easily be substituted for improved hardware or firmware arrangements as they are developed.

Storage device 530 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 525, read only memory (ROM) 520, and hybrids thereof.

Storage device 530 may include services 532, 534, and 536 for controlling the processor 510. Other hardware or software modules are contemplated. Storage device 530 may be connected to system bus 505. In one aspect, a hardware module that performs a particular function may include the software component stored in a computer-readable medium in connection with the necessary hardware components, such as processor 510, bus 505, output device 535, and so forth, to carry out the function.

FIG. 5B illustrates a computer system 550 having a chipset architecture that may represent at least a portion of organization computing system 104. Computer system 550 may be an example of computer hardware, software, and firmware that may be used to implement the disclosed technology. System 550 may include a processor 555, representative of any number of physically and/or logically distinct resources capable of executing software, firmware, and hardware configured to perform identified computations. Processor 555 may communicate with a chipset 560 that may control input to and output from processor 555. In this example, chipset 560 outputs information to output 565, such as a display, and may read and write information to storage device 570, which may include magnetic media, and solid-state media, for example. Chipset 560 may also read data from and write data to RAM 575. A bridge 580 for interfacing with a variety of user interface components 585 may be provided for interfacing with chipset 560. Such user interface components 585 may include a keyboard, a microphone, touch detection and processing circuitry, a pointing device, such as a mouse, and so on. In general, inputs to system 550 may come from any of a variety of sources, machine generated and/or human generated.

Chipset 560 may also interface with one or more communication interfaces 590 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 555 analyzing data stored in storage device 570 or RAM 575. Further, the machine may receive inputs from a user through user interface components 585 and execute appropriate functions, such as browsing functions by interpreting these inputs using processor 555.

It may be appreciated that example systems 500 and 550 may have more than one processor 510 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed is:

1. A computer-implemented method for generating a smart overlay in an interactive display, the method comprising:
receiving, by one or more processors, a plurality of real-time event data comprising a plurality of real-time event actions;
receiving, by the one or more processors, a plurality of user data comprising a plurality of user actions;
capturing, by the one or more processors, one or more real-time user interactions with the interactive display;
generating, by the one or more processors, a unique relevancy threshold using the plurality of real-time event actions, the plurality of user actions, and the one or more real-time user interactions, wherein the unique relevancy threshold is generated in real-time as the plurality of real-time event data and the one or more real-time user interactions are received;
generating, by the one or more processors and in real-time, at least one unique smart overlay that has a relevancy that exceeds the unique relevancy threshold; and
updating, by the one or more processors and in real-time, the interactive display with the at least one unique smart overlay.

2. The computer-implemented method of claim 1, wherein the at least one unique smart overlay is an interactive interface overlaid on a live video stream on a user device.

3. The computer-implemented method of claim 1, wherein a position of the at least one unique smart overlay within the interactive display is automatically determined based on one or more of the plurality of real-time event actions, the plurality of user actions, the one or more real-time user interactions, and a camera angle of a live video stream.

4. The computer-implemented method of claim 1, wherein the at least one unique smart overlay is generated and/or updated based on one or more of the plurality of real-time event actions, the plurality of user actions, and the one or more real-time user interactions.

5. The computer-implemented method of claim 1, wherein the interactive display is displayed on a user mobile device.

6. The computer-implemented method of claim 1, wherein the plurality of real-time event actions include at least one of a scored goal, a completed pass, an interception, a goal conceded, or no action.

7. The computer-implemented method of claim 1, wherein one or more of the unique relevancy threshold, the plurality of real-time event actions, the plurality of user actions, and the one or more real-time user interactions is provided to one or more artificial intelligence models as input.

8. A system for generating a smart overlay in an interactive display, the system comprising:
a memory storing instructions and a processor operatively connected to the memory and configured to execute the instructions to perform operations including:
receiving, by one or more processors, a plurality of real-time event data comprising a plurality of real-time event actions;
receiving, by the one or more processors, a plurality of user data comprising a plurality of user actions;
capturing, by the one or more processors, one or more real-time user interactions with the interactive display;
generating, by the one or more processors, a unique relevancy threshold using the plurality of real-time event actions, the plurality of user actions, and the one or more real-time user interactions, wherein the unique relevancy threshold is generated in real-time as the plurality of real-time event data and the one or more real-time user interactions are received;
generating, by the one or more processors and in real-time, at least one unique smart overlay that has a relevancy that exceeds the unique relevancy threshold; and
updating, by the one or more processors and in real-time, the interactive display with the at least one unique smart overlay.

9. The system of claim 8, wherein the at least one unique smart overlay is an interactive interface overlaid on a live video stream on a user device.

10. The system of claim 8, wherein a position of the at least one unique smart overlay within the interactive display is automatically determined based on one or more of the plurality of real-time event actions, the plurality of user actions, the one or more real-time user interactions, and a camera angle of a live video stream.

11. The system of claim 8, wherein the at least one unique smart overlay is generated and/or updated based on one or more of the plurality of real-time event actions, the plurality of user actions, and the one or more real-time user interactions.

12. The system of claim 8, wherein the interactive display is displayed on a user mobile device.

13. The system of claim 8, wherein the plurality of real-time event actions include at least one of a scored goal, a completed pass, an interception, a goal conceded, or no action.

14. The system of claim 8, wherein one or more of the unique relevancy threshold, the plurality of real-time event actions, the plurality of user actions, and the one or more real-time user interactions is provided to one or more artificial intelligence models as input.

15. A non-transitory computer-readable medium storing instructions that, when executed by one or more processors, perform a method for generating a smart overlay in an interactive display, the method comprising:
receiving, by one or more processors, a plurality of real-time event data comprising a plurality of real-time event actions;
receiving, by the one or more processors, a plurality of user data comprising a plurality of user actions;
capturing, by the one or more processors, one or more real-time user interactions with the interactive display;
generating, by the one or more processors, a unique relevancy threshold using the plurality of real-time event actions, the plurality of user actions, and the one or more real-time user interactions, wherein the unique relevancy threshold is generated in real-time as the plurality of real-time event data and the one or more real-time user interactions are received;
generating, by the one or more processors and in real-time, at least one unique smart overlay that has a relevancy that exceeds the unique relevancy threshold; and
updating, by the one or more processors and in real-time, the interactive display with the at least one unique smart overlay.

16. The non-transitory computer-readable medium of claim 15, wherein the at least one unique smart overlay is an interactive interface overlaid on a live video stream on a user device.

17. The non-transitory computer-readable medium of claim 15, wherein a position of the at least one unique smart overlay within the interactive display is automatically determined based on one or more of the plurality of real-time event actions, the plurality of user actions, the one or more real-time user interactions, and a camera angle of a live video stream.

18. The non-transitory computer-readable medium of claim 15, wherein the at least one unique smart overlay is generated and/or updated based on one or more of the plurality of real-time event actions, the plurality of user actions, and the one or more real-time user interactions.

19. The non-transitory computer-readable medium of claim 15, wherein the interactive display is displayed on a user mobile device.

20. The non-transitory computer-readable medium of claim 15, wherein one or more of the unique relevancy threshold, the plurality of real-time event actions, the plurality of user actions, and the one or more real-time user interactions is provided to one or more artificial intelligence models as input.
